(19) United States
(12) Patent Application Publication
(10) Pub. No.: US 2015/0088573 A1
(43) Pub. Date: Mar. 26, 2015

(54) AUTOMATIC TRACKING SYSTEM FOR LANGUAGE LEARNING VIA ONLINE SESSIONS

(71) Applicant: Andres Abeyta, San Diego, CA (US)

(72) Inventor: Andres Abeyta, San Diego, CA (US)

(21) Appl. No.: 14/491,902

(22) Filed: Sep. 19, 2014

Related U.S. Application Data
(60) Provisional application No. 61/880,839, filed on Sep. 20, 2013.

(51) Int. Cl. G09B 19/06; G06Q 20/14; G06Q 50/20; G09B 5/06; G06Q 10/10

(52) U.S. Cl. CPC G09B 19/06; G09B 5/065; G06Q 10/1093; G06Q 50/20; G06Q 20/14
USPC 705/7.18; 434/157

(57) ABSTRACT

An online learning platform for improvement of language conversation skills with management tools to control timing and monetization of the session. Web platform includes tutor search, scheduling, social networking, video viewer, and payment processes in a fully integrated package to create open and safe environment for language students. Students use the platform search process to find a tutor that matches their conversation needs. Tutors and Students use the integrated scheduling process to coordinate conversation sessions, called Vee-sessions. Students and tutors can communicate via social networking tools within the platform as well as linked to other existing social networking platforms. A student and tutor conduct an online video conversation and use language-learning tools to assist improvement in student oral communication abilities. The online learning environment includes a video player, a live chat/messaging portal, image sharing widget, translation widget, dictionary widget, news feed widget, and test scenario widget.

This application claims the benefit of U.S. provisional application Ser. No. 61/880,839 filed Sep. 20, 2013, the content of which is incorporated herein in its entirety This invention relates to the field of online language instruction and learning. More specifically, it relates to a compiled environment that encourages and supports conversation skill improvements through various levels of interaction while also providing a management control to monetize the experience.

### BACKGROUND OF THE INVENTION

### Field of the Invention

Learning a second language is a difficult task at best. Students have to work very hard learning grammar, comprehension and vocabulary. Generally, students do well on their exams in these areas; however, conversational-based testing has proven to be the most challenging for new language learners. Current pedagogy recognizes that learning is more effective when the focus is on the learner. Studies have also shown that one-on-one tutoring that puts the students in the center of the learning process has significantly better results than standard classroom study. One-on-one conversations remove the largest barriers for language learners. They provide a safe, learner-centered environment where the student's efforts are supported. Add in the online aspect where students sit at their own desks, in front of their own computers, in their own homes; the holistic experience dramatically improves performance, lowers anxiety and increases motivation to break through the language barrier.

Tutoring is especially effective in meeting the special challenges of language learning. Motivation is key to all learning and it is essential for language learners who must deal with the frustration of limited communication, learning plateaus, and the length of time it takes to reach fluency. Researchers estimate it takes 600 hours of intense instruction and individual attention to reach proficiency. Having tutor interaction encourages constant practice to master any new language. Additionally, access to conversation partners similar to immersion programs increases fluency. If students have the option to choose their tutor from a wide variety of profiles, they have the ability to select a tutor who shares their interests, someone they can talk to about things they want to discuss—essentially, language learning in context. Learning in context reduces anxiety, gives the student the motivation to continue to practice, and takes focus off specific conversation skill learning.

Additionally, language learning is more effective when it is easily accessible and works with online. If a user can comfortably navigate a tutoring site—registering, searching for a tutor, scheduling a session, and calling, this is an effective use of online tools to help students. Further, a learning environment where students can learn and communicate with their peers can appreciably enhance communication and collaboration and improve the learning experience.

Existing online sites miss the crucial mix of tutors, learning and social tools, as well as flexibility in usage, payment and availability to be fully effective. A solution that utilizes the best practice of conversations with a tutor of like interests and using readily available tools to practice and improve oral communication skills in an effective, easy and connected online environment is needed. A solution that also has built in controls to monetize the experience is a unique invention.

### SUMMARY OF THE INVENTION

Accordingly, the present invention provides an online learning platform for improvement of language conversation skills with management tools to control and monetize the session. The invention is a platform that offers search, schedule and video streaming tools with automatic tracking of tutoring transactions between independent students and tutors. It utilizes the best practice of language conversations and online media with a tutor of like interests.

In the first aspect, the platform is a search and scheduling engine to connect a student with an appropriate tutor. The student accesses a search process that employs several methodologies for finding the right tutor for them. Students can search by keyword or preferences or they can search by geographical location via TheTalkMap (trademark pending). The student has the opportunity to filter results based on integrated grading system of tutors, by location, or visual inspection of the tutor's profile. The student can save tutors or can proceed directly to the Scheduling process. The scheduling process coordinates the available sessions for both tutors and students across all time zones and international boundaries. All participants see their local time for ease of scheduling while the scheduling process coordinates the booking and billing to ensure a smooth Vee-session (i.e., real time, on-line, virtual face to face tutoring) experience and accurate transactions.

As a part of this first aspect, the search and scheduling engine has a separate on-demand capability that works in coordination with a mobile app. Rather than advance booking, students can use this capability to find, text chat with, book and enter a Vee-session instantly.

In the second aspect, the platform is a fully functional videoconference that incorporates additional learning tools to help the student improve their conversational skills. The student and tutor enter the Vee-session site from a web site that has allowed the student and tutor to schedule their 25-minute conversation session. The Vee-session occurs within a fully automated site that controls the start and finish to the session to ensure accurate billing. Once in the session, or Vee-session, the student and the tutor engage in a video conversation and make use of the available language learning tools to help the student improve their conversation skills. All feedback, messaging, quality controls and billing functions happen automatically so that the student and tutor can focus on their conversation and improve the students speaking ability.

As part of this aspect, The Vee-session site is a videoconference environment where both the student and tutor can see and talk to teach other. The ability to be able to see and hear pronunciation and usage is important to language conversation proficiency. For the student, confidence is increased when they look at the tutor face to face. For the tutor, being able to visually see if the student is struggling or is comfortable allows adjustments to maximize the learning experience and ensuring an enjoyable session.

Vee-session is virtual training session that can be generalized as a peer to peer language learning environment wherein tutors and students join together online in a video session to teach and learn language conversation. The environment offers translation, definitions, chat and news topics. The Vee-session has automatic monitoring, messaging and monetization.

In another part of this second aspect, the Vee-session is a highly flexible learning environment that can bring in translations; definitions; images; current news: and test scenarios into the conversation to help the student better understand the nuances of the language being learned. These tools access information readily available on the Internet thus the useable information remains fresh and relevant.

In the third aspect of the invention, the platform is an online repository for learning and teaching materials for tutor access. This repository contains multimedia materials and links that are consistently updated to remain fresh and relevant.

As a part of this third aspect, the platform matches the online repository with a qualification process to ensure that tutors are knowledgeable on running the platform, on key needs of students, on language conversation techniques, and on the information in the respository.

In a fourth aspect of the invention, the platform is a functional social networking site. Students and tutors have access to an email system, Beepbox, that is also linked to their personal email; a live chat site where they can communicate in real time; and connections to other social networking platforms to expand their access to their friends from the site.

Social networks connect people electronically across distances, ages, and professions. To quantify the connectivity within TheTalkList global network, we have calculated a measure for each member called the Social Networking Index (SNI) This is visible on the member's dashboard (1513). As part of each member's profile, this quantitative index is displayed and automatically increments as the member's connectivity to other members increases. The contributing components that figure into the statistic include: distributed geography, professional keywords, age, and education. As each member develops a learning interaction with a new member, these components are mined and analyzed from the new member's profile. A value is calculated and added to the current SNI of both members that are connecting. The larger the value, the better connected the person is with people of influence.

This index is listed within the profile of each member and acts as a sense of stature as they connect with people around the world. It is automatically calculated and is not editable.

In a fifth aspect of the invention, the platform is a fully monitored, timed and controlled marketplace platform. Tutors are free to set their rates and students can choose the rates they want to pay without negotiating. Tutors can improve their placement by the full suite of automated modules that controls all administrative functions. Start and finish times are controlled, monitored and presented in automated messages to clarify the parameters of the Vee-session to both participants. The timing module is coordinated with the Billing module for accurate debit of credits and payments.

As a part of this aspect, tutors can produce and sell teaching videos that students can purchase for download. These videos are in addition to the Vee-sessions that students can book and video sales site is directly connected to the billing system to ensure prompt payment.

In sixth aspect, the platform is a quality control system for a safe online experience. The user feedback and quality control modules ensure that students have an appropriate and proper session. These modules interface with the Billing module for any refund requirements. The user feedback module also provides grading and assessments information of tutors to the search interface of TheTalkList platform.

In a final aspect of the invention, TheTalkList platform is available to browser applications for desktop operating systems and mobile applications for smartphone and tablet operating systems.

### BRIEF DESCRIPTION OF THE DRAWINGS

The invention is better understood with the detailed description provided hereinafter. Included with the description is a reference to all figures. The drawings are for the purpose of illustration only, and thus are not limitative of the invention, wherein:

FIG. 1 shows the wireframe design of the Vee-session User interface. This interface is presented to both the student and tutor via commonly available web browsers. The illustration provides a perspective of various elements of the invention's user interface including the Video Viewer Tokbox (WebRTC), Live Chat/TTL control messaging and various other modules that are included in the invention user interface.

FIG. 2A shows the overall Vee-session process in a flow chart schematic diagram. The processes described in FIGS. 3-9 interact with the Vee-session process to provide complete automation and control of the Vee-session process allowing the users to focus on their conversation. The invention “Vee-Session Process” includes numerous steps which are illustrated and include but are not limited to checking the session status, engaging in live chat, engaging in a video process, use of timing to measure the session between tutor and student. FIG. 2B is a continuation of the flow chart of FIG. 2A and includes a step for ending the Vee-session between tutor and student.

FIG. 3 shows the process to allow users to enter the site. This process ensures that the participants have the proper resources and credits before beginning the session. The User entry process interacts with the Vee-session process described in FIG. 1 as well as scheduling process briefly described in this patent. Provided in the Figure are several elements and steps associated with beginning a tutoring session including but not limited to checking for a connection to the tutor session, checking that the instructor and student are connected for a session, a step that indicates that the session can proceed and a step that ends the user entry process.

FIG. 4A shows the system messaging process that monitors the timer (as shown in FIG. 8) and accesses the appropriate messages from the system messages database (as shown in FIGS. 11A and 11B) and presents them to the Live Chat Process (as shown in FIGS. 6A and 6B).

FIG. 4B illustrates the System Messaging Process that enables a user to connect and send messages to other users. The Figures provides steps involved in the process of connecting and sending messages in the messaging process.

FIG. 4C illustrates additional elements and steps associated with the System Messaging Process. In particular, included in the depiction is a flow chart schematic that provides a “yes” and “no” decision tree to accomplish particular steps in the messaging process.

FIG. 4D illustrates a flow chart of additional steps included in the tutor session conducted between tutor and student. In particular the Figure illustrates steps involved in sending messages to a tutor and a student.

FIG. 4E illustrates a flow chart of additional steps included in the system messaging process. In particular, steps related to sending messages to a student and a tutor are provided.

FIG. 4F illustrates a flow chart of additional steps included in the system messaging process. In particular, steps related to sending messages to a tutor and student are provided.

FIG. 4G illustrates a flow chart of additional steps included in the system messaging process of the system platform. In particular, steps involved in sending messages to either a tutor or a student are provided.

FIG. 4H illustrates a flow chart of additional steps included in the system messaging process of the system platform. In particular, the Figure depicts a relation between sending messages and the live chat capability of the invention,

FIG. 5 shows the process for engaging the Video Viewer. This process interacts and relates with FIG. 2, The Vee-session process and FIGS. 10A and 10B, the User Exit Process. The Video Viewer presents itself in the User Interface shown in FIG. 1. The video viewer also interacts with functions that are outside the scope of this patent application.

FIG. 6A, shows the Live Chat process that presents its output in the User interface depicted in FIG. 1. The Live Chat Process interacts with the System messages (FIG. 4) and the Vee-session Exit Process (FIGS. 10A and 10B). FIG. 6B is a continuation of the flow chart of FIG. 6A.

FIG. 7A, shows the Workspace Process that presents its output in the User Interface depicted in FIG. 1. The Workspace interacts with functions outside the scope of this patent application as well as the Vee-session process (FIG. 2) and the User Exit Process (FIG. 9). FIG. 7B is a continuation of the flow chart of FIG. 7A and depicts various displays of the invention including images and newsfeeds. FIG. 7C is a continuation of the flow charts of FIGS. 7A and 7B and depicts a decision tree for a workspace aspect of the system invention.

FIG. 8, Timer, shows the timing function that interacts with FIGS. 2, 4, 9, and 10, the Vee-session, the System Messaging, the User Exit and Vee-session Exit processes, respectively.

FIG. 9 shows aspects of the User Exit Process. This process monitors the exiting parties from the Vee-session to determining proper messaging and billing for the participants in the Vee-session. Its interactions were previously mentioned heretofore.

FIG. 10A, shows aspects of the Vee-session Exit Process. It interacts with processes mentioned heretofore. This process also interacts with processes outside the scope of this patent application and these non-described processes will be presented in a future patent application specifically for their unique properties and capabilities. FIG. 10B is a continuation of the flow chart of FIG. 10A and depicts the final steps of the Vee-session Exit Process.

FIG. 11A, shows aspects of the system messages contained in the system-messaging database. The numbered messages are referenced in FIG. 4, System Messaging, and FIG. 10, User Exit Process. FIG. 11B is a continuation of the system messages features described in FIG. 11A.

FIG. 12 shows the wireframe design of the Tutor Search User Interface. This user interface is presented to the student to aid them in choosing a tutor that meets their conversational needs. This interface works directly with the Tutor search process in FIG. 13.

FIG. 13A, shows the high level Tutor search process that students use to find their tutor for their Vee-sessions. The process relies on manual input from the Tutor search UI (FIG. 12) and searches the tutor profile database for matches.

FIG. 13B illustrates a continuation of the tutor search process of FIG. 13A. Among the steps illustrated in the Figure is the ability to view a tutor's profile page and to view the tutor's profile picture.

FIG. 13C illustrates a continuation of the tutor search process of FIGS. 13A and 13B. In particular, among the steps depicted is the ability to view the profile page of a selected tutor and to correspond with that tutor.

FIG. 13D illustrates a continuation of the tutor search process of FIGS. 13A, 13B and 13C. In particular, among the steps depicted is the ability to end the tutor search process.

FIG. 14 shows the wireframe of Tutor profile page that provides the student details on a particular tutor that was selected from the Tutor search page (FIG. 12). This profile page displays the information from the tutor profile database for a particular tutor. That tutor manually inputs the information into their profile.

FIG. 15, shows the wireframe of the Calendar page for the Tutor views. This User Interface works directly with the Scheduling process and is the interface to advance schedule a Vee-session with a Tutor.

FIG. 16, is a continuation of the wireframe of the Calendar page (FIG. 15) for the Tutor view. In particular, the Figure depicts a period recurrence feature of the tutor view.

FIG. 17 illustrates the wireframe of the Calendar page for the Student views. This User Interface works directly with the Scheduling process and is the interface to advance schedule a Vee-session with a Tutor.

FIG. 18A shows the Scheduling process the students and tutors use to coordinate Vee-sessions. The 3 paths to scheduling are mapped out in FIGS. 18A through 18H. This scheduling process provides automated input to the Vee-session process to control the start of scheduled Vee-sessions. This process works with the Calendar page (FIG. 15), student calendar database and tutor calendar database.

FIG. 18B illustrates aspects of the scheduling processes and subroutines of the system invention. In particular, recurring scheduling is depicted providing for example, a weekly calendar.

FIG. 18C illustrates aspects of the scheduling processes and subroutines of the system invention. In particular, steps related to a student booking time with a tutor are provided.

FIG. 18D illustrates aspects of the scheduling processes and subroutines of the system invention. In particular, steps related to reservation of a day and time for a tutoring session are provided.

FIG. 18E illustrates aspects of the scheduling processes and subroutines of the system invention. In particular, a decision tree of aspects of reserving a day and time with a tutor are provided. Also provided are aspects of changing or cancelling a tutor session are provided.

FIG. 18F illustrates aspects of the scheduling processes and subroutines of the system invention. In particular, aspects of searching for a tutor are provided.

FIG. 18G illustrates aspects of the scheduling processes and subroutines of the system invention. In particular, aspects of monitoring reserved time slots are provided.

FIG. 18H illustrates aspects of the scheduling processes and subroutines of the system invention. In particular, aspects of the Talk Now process are depicted including ending the Talk Now process.

FIG. 19 shows the wireframe of the Video Search User interface. Similar to the Tutor search, this User Interface allows the student to find, purchase and download video lessons. This interface works directly with the Video search process (FIGS. 20A and 20B).

FIG. 20A shows the video search process that allows a student to find, purchase and download video lessons. This process works directly with FIGS. 20A and 20B, the video search UI and the video lesson storage where the tutors manually upload their content. FIG. 20B is a continuation of the flow chart steps of FIG. 20A and illustrates the steps of purchasing and downloading video lessons.

FIG. 21, represents the wireframe of the Dashboard having a Student View and a Tutor View. The Dashboard is an online hangout for students and tutors where they can communicate via several methods—email (Beepbox), Instant messaging (Live Chat) and monitoring of TheTalkList Facebook feed. The Dashboard variances between the Student and the Tutor Dashboards are outlined in the figure. From the Dashboard, the student or the tutor can navigate to other areas of the web site.

FIG. 22, represents the wireframe of the Dashboard having a Student View and a Tutor View. The Dashboard is an online hangout for students and tutors where they can communicate via several methods—email (Beepbox), Instant messaging (Live Chat) and monitoring of TheTalkList Facebook feed. The Dashboard variances between the Student and the Tutor Dashboards are outlined in the figure. From the Dashboard, the student or the tutor can navigate to other areas of the web site.

### DETAILED DESCRIPTION OF THE INVENTION

The overall invention is best understood when all aspects of the invention are described in the standard use case. The core capability of the site is a monitored Viewer, called a Vee-session, where the student and tutor conduct their language conversation practice. The Vee-session is a controlled viewer with tools designed specifically for a timed and monetized language learning experience. The other aspects assist the student and tutor to arrive at the Vee-session, help the tutor or student with other teaching materials, communicate with others or monitor/control the entire site for monetization of the Vee-session experience.

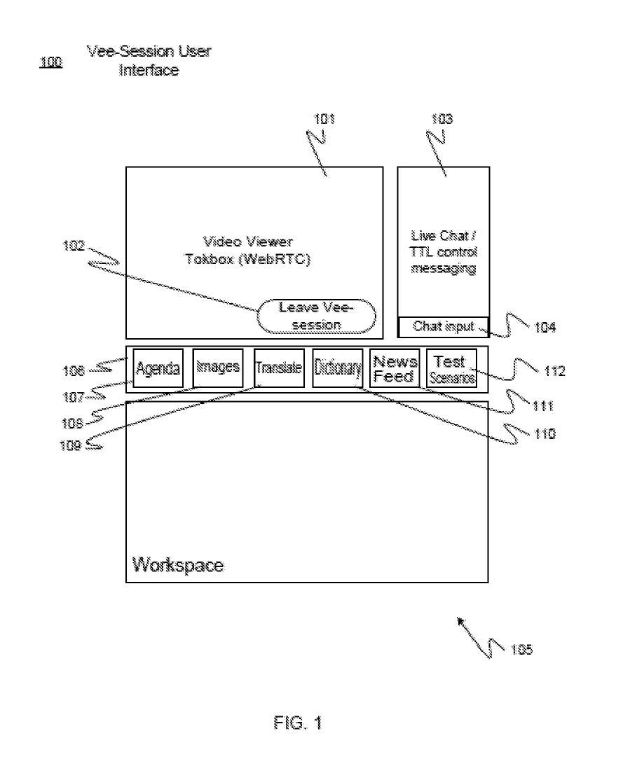

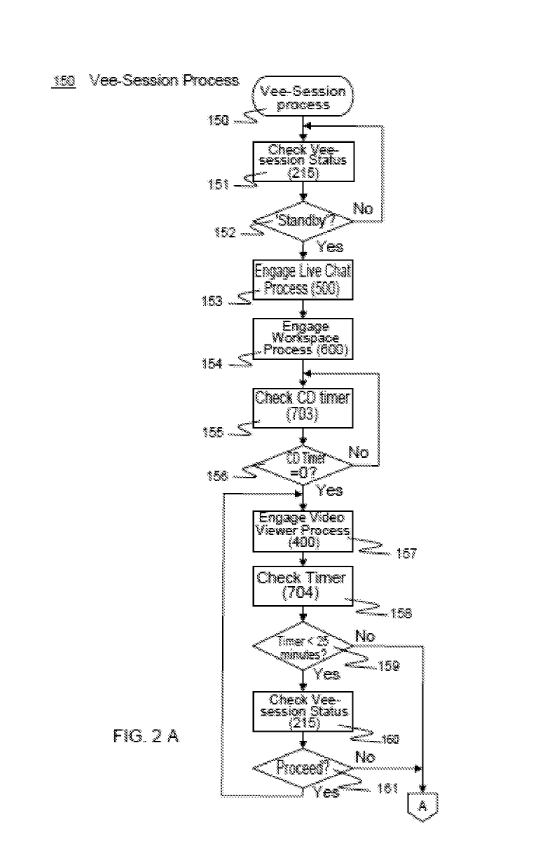

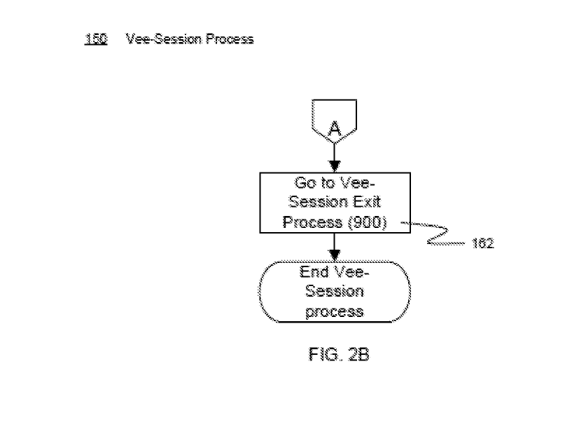

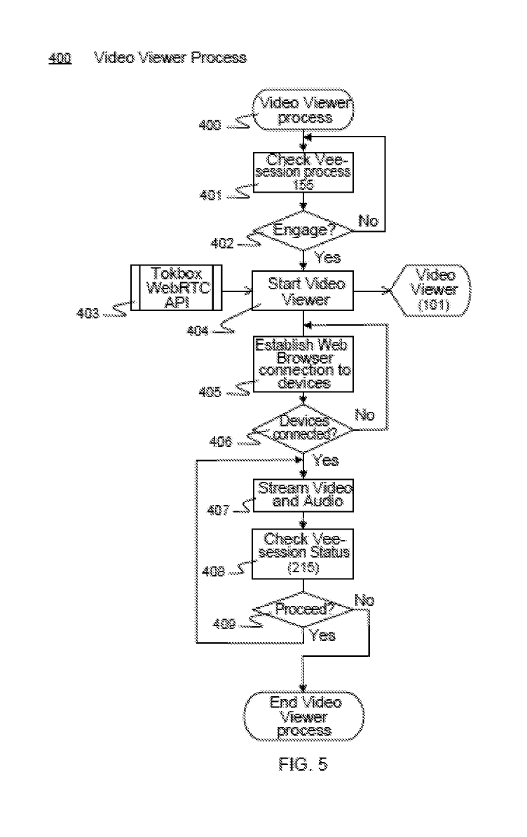

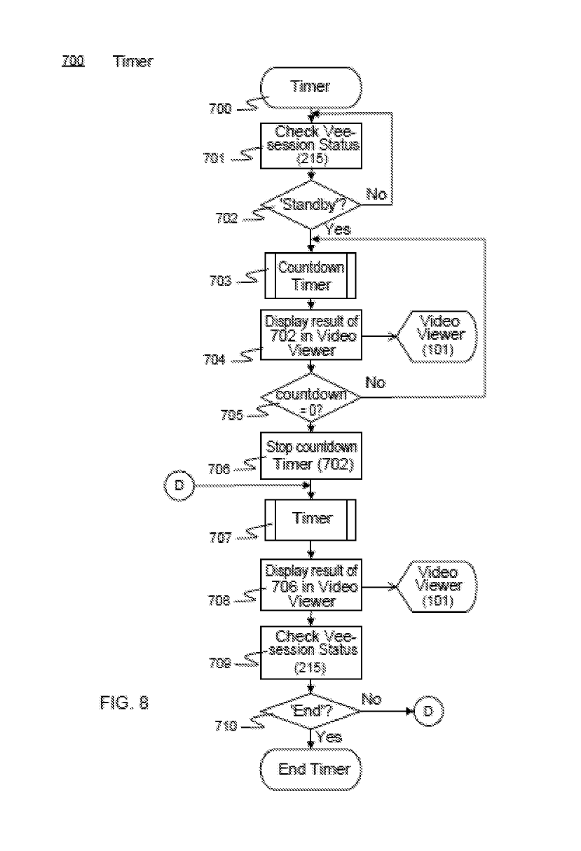

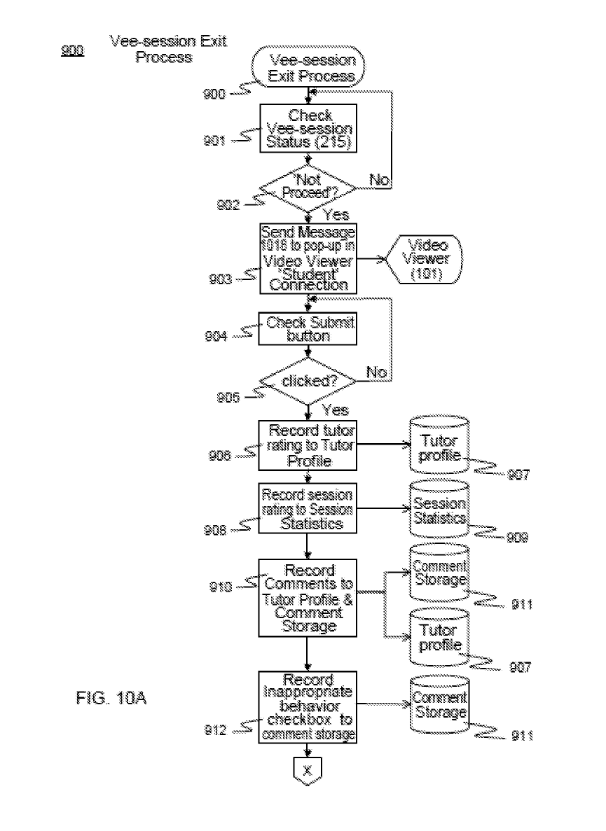

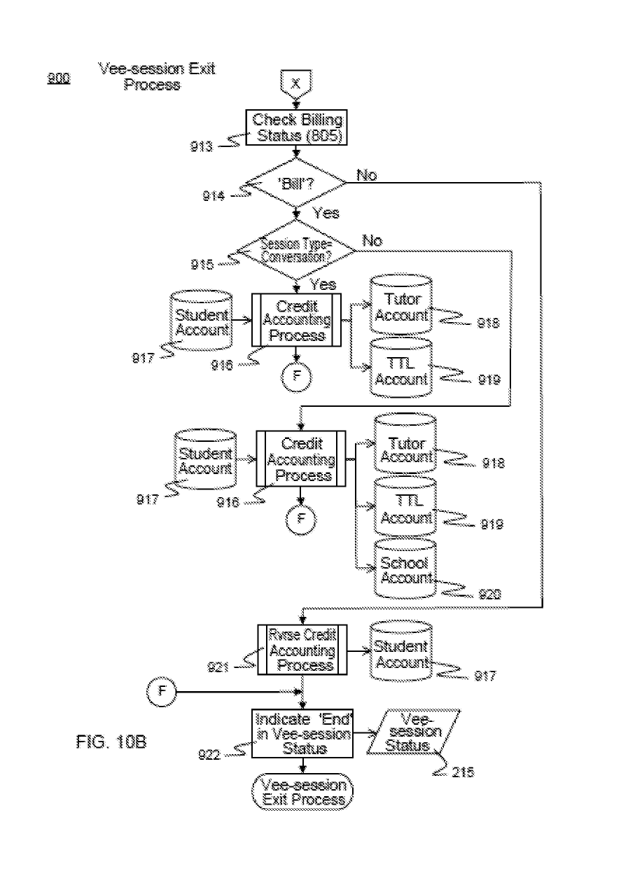

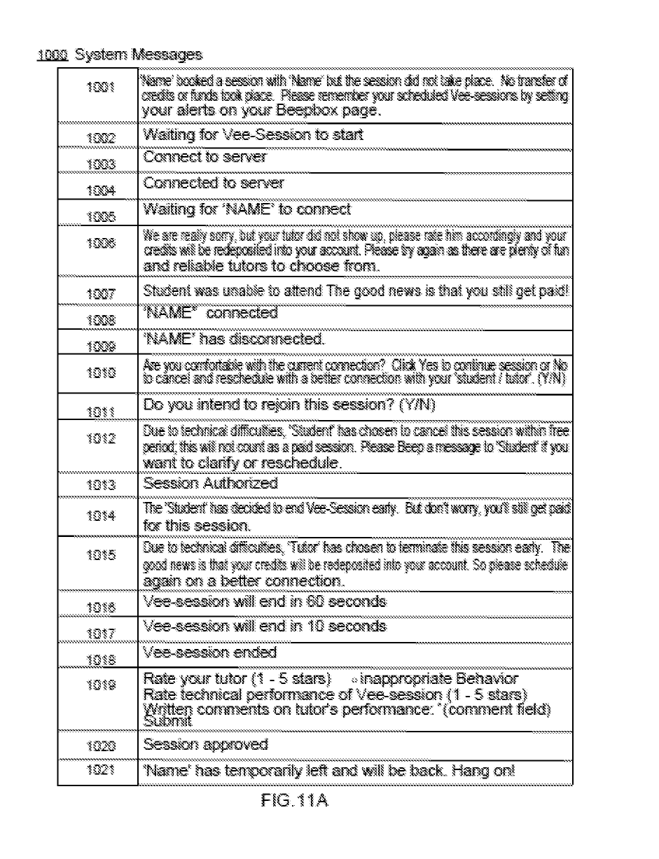

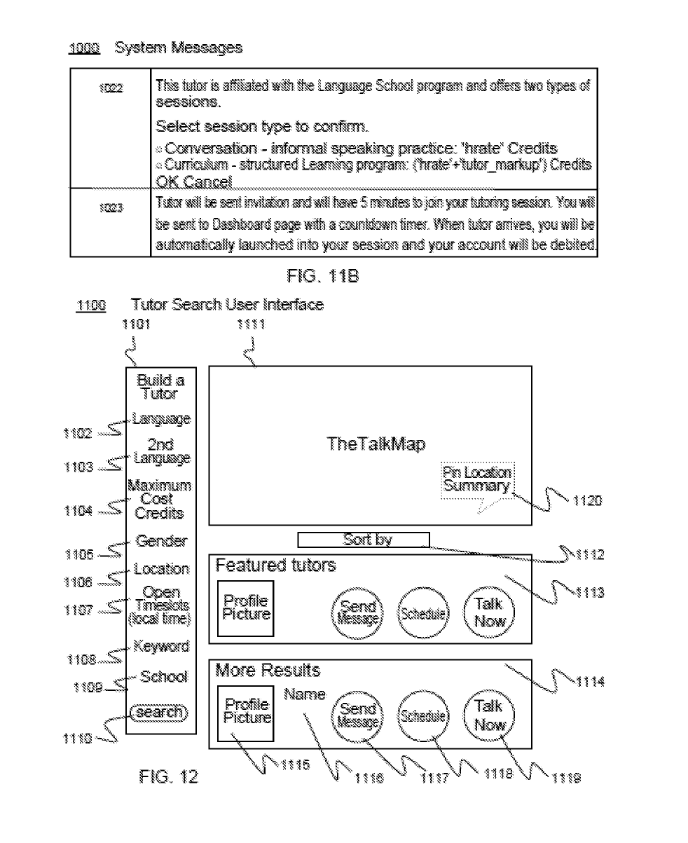

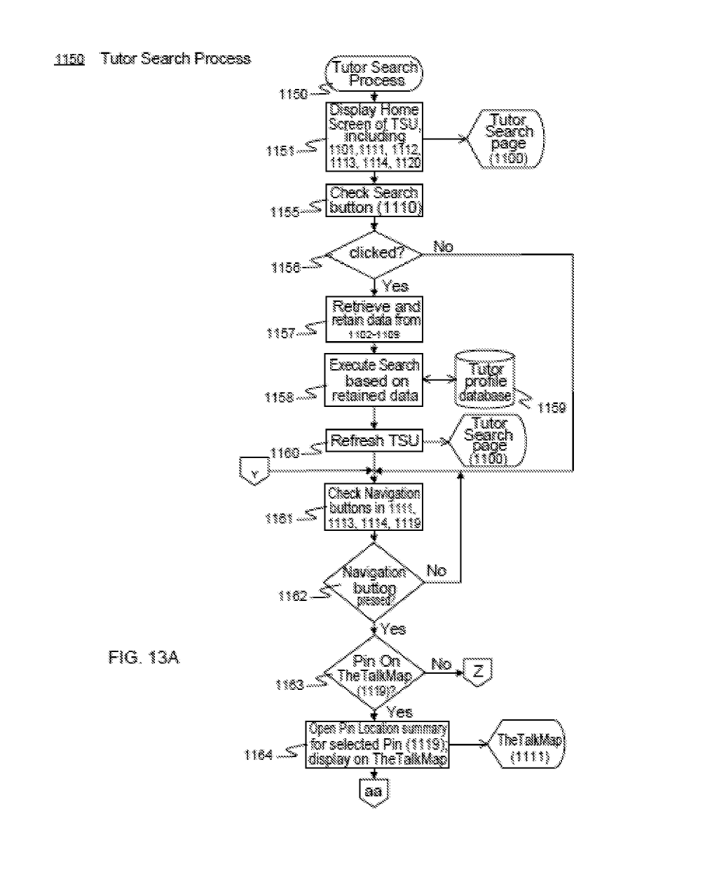

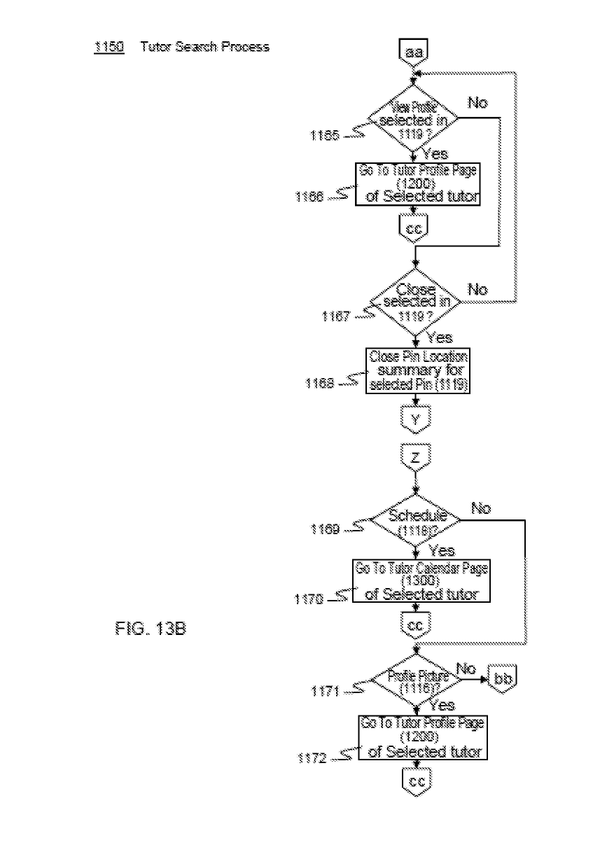

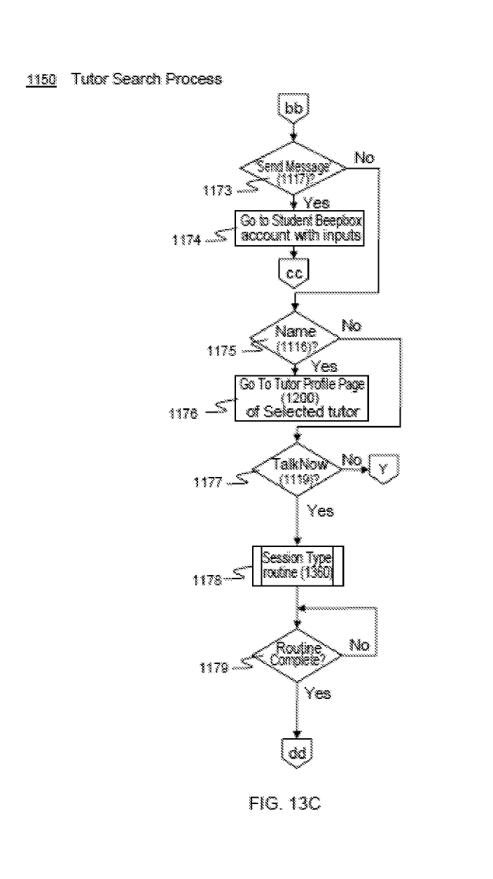

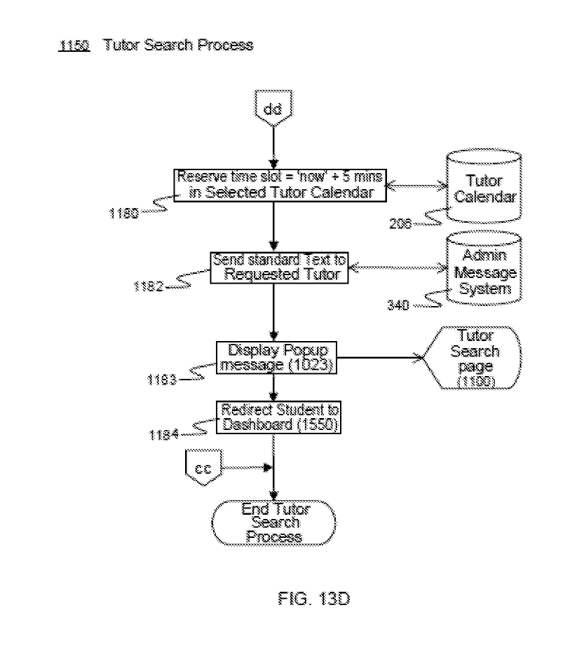

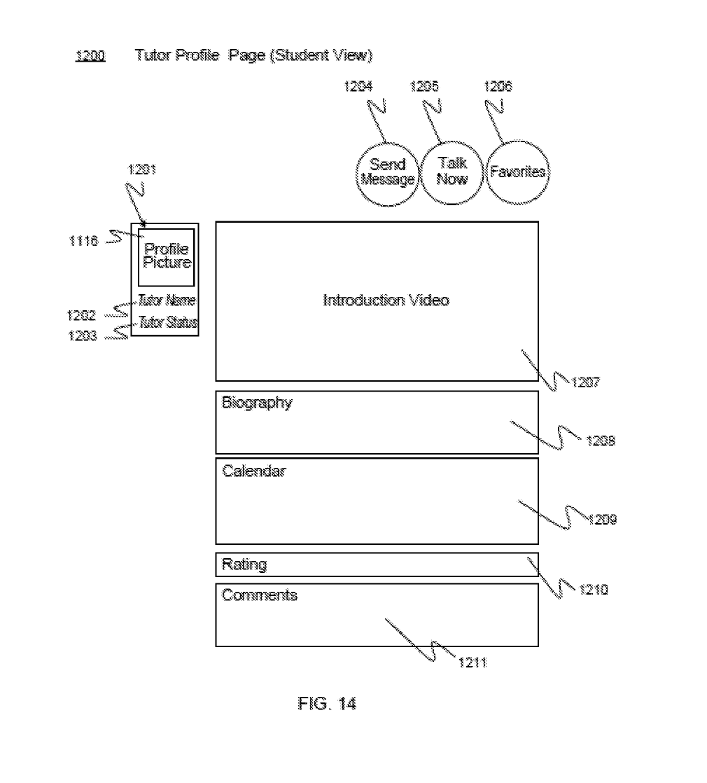

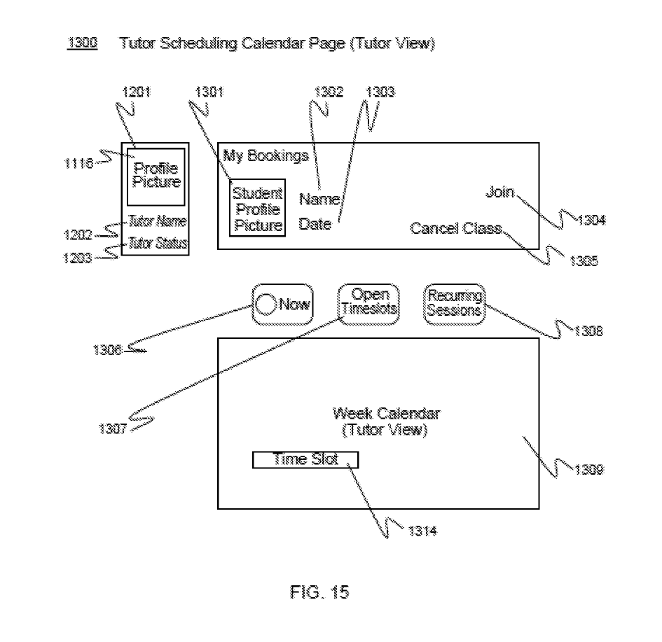

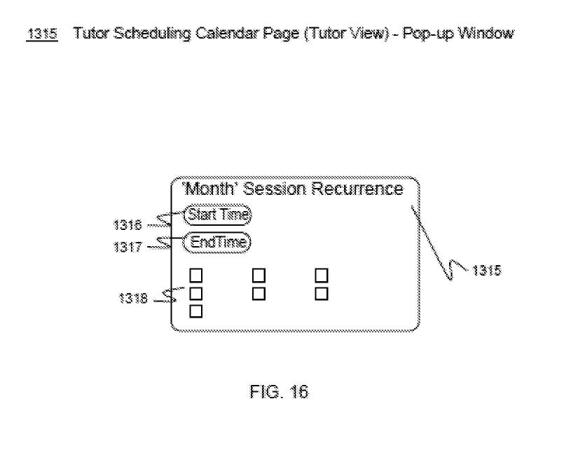

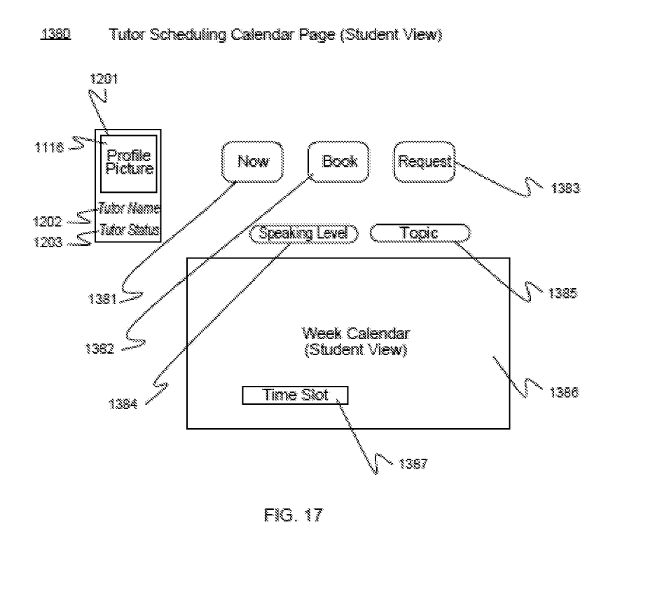

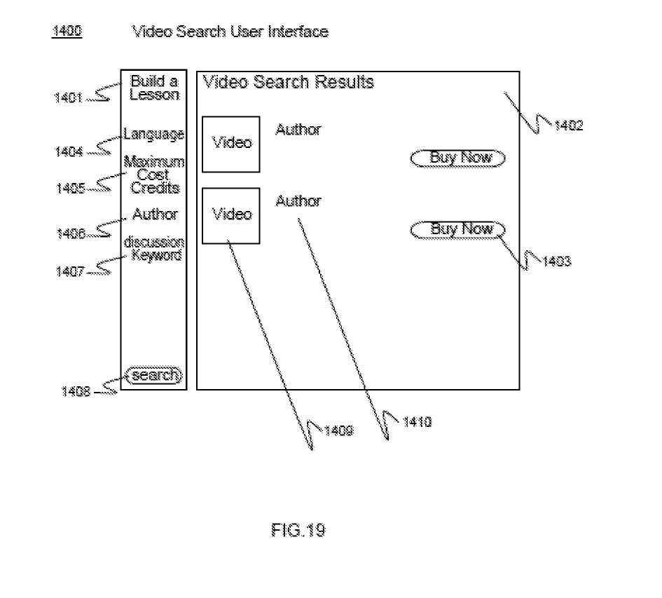

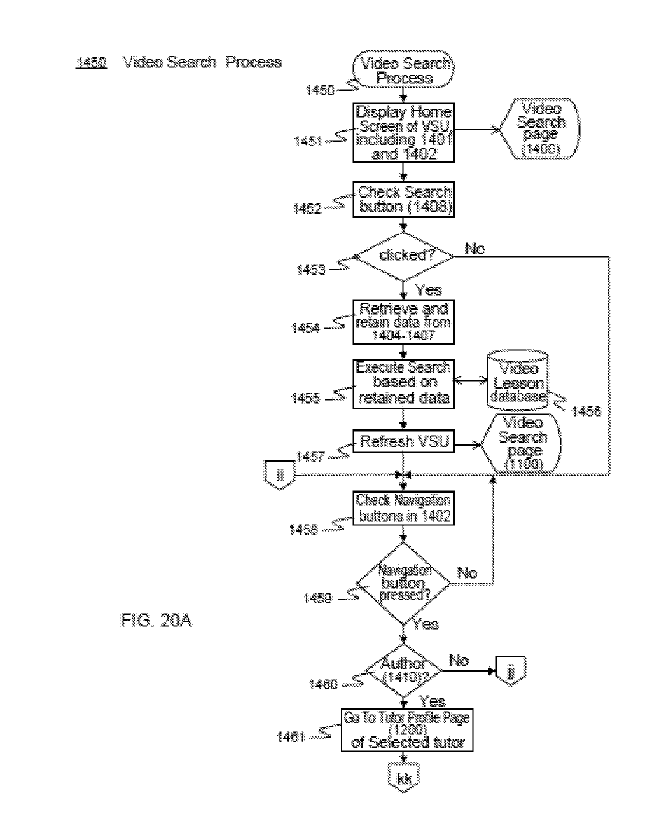

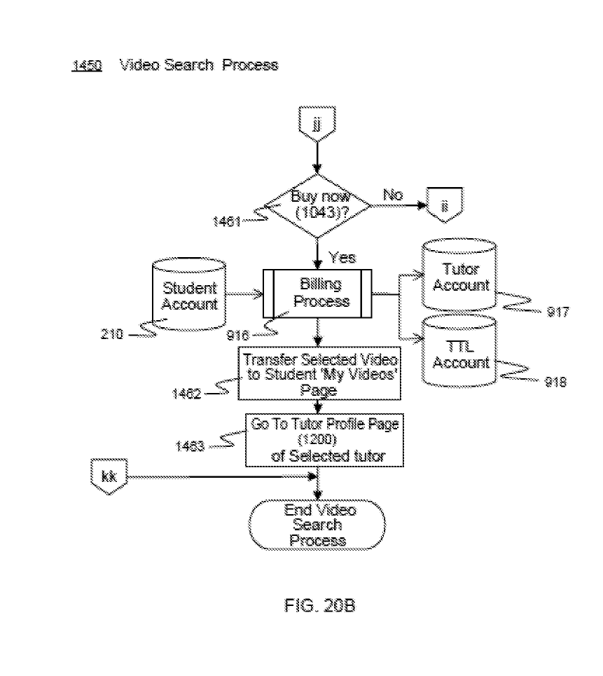

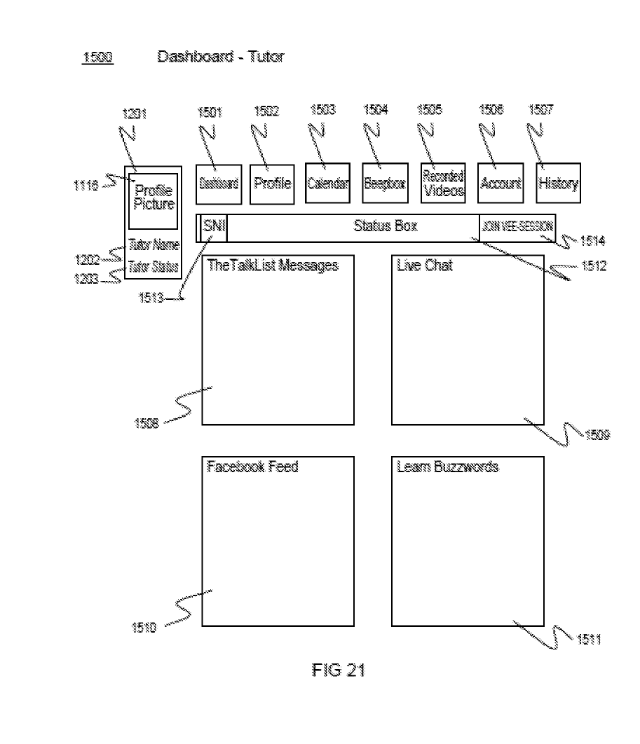

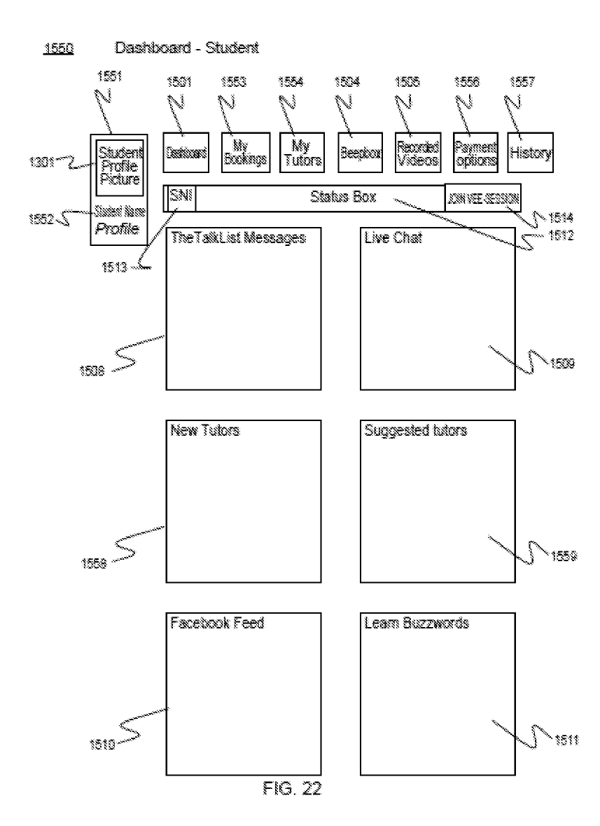

Turning now to the substance of FIGS. 1 to 22 and the preferred embodiments of the invention. Starting with explaining the Vee-session will clarify how the other functions and capabilities of the invention work and interact. These additional capabilities will be explained herein. FIG. 1 illustrates the initial steps in accessing the system application invention. The Vee-session starts when the Video Viewer process (400) sets the Start Video Viewer (404) (FIG. 5) to ‘Yes.’ The changing of the status triggers the start of the Timer (701, 702), (FIG. 8) the Vee-session Process (VSP) (151, 152), (FIG. 2A) and System Messaging Process (SMP) (301, 302). The Scheduling process sets Vee-session process to ‘standby’ 15 minutes prior to the start of the Vee-session.

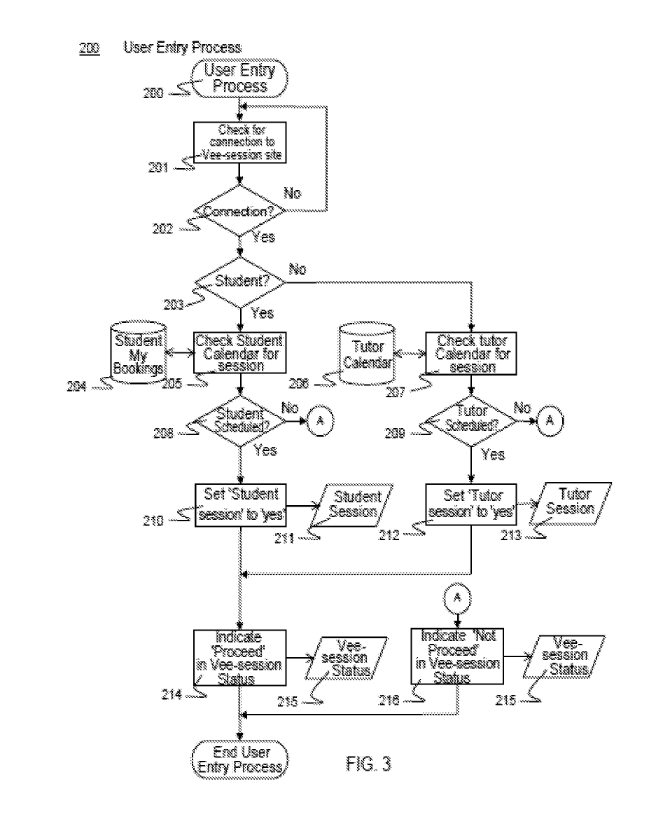

The Vee-session waits in standby until a qualified connection joins the Vee-session. The User Entry Process (UEP) (200) (FIG. 3) monitors for connections. As long as there are no connections, the UEP holds. At the presence of a connection, the UEP checks to see if the connection is associated with a tutor or a student. If a Student, the UEP checks (205) the Student Calendar (204) to confirm the session. If valid, the UEP sets (210) the Student Session (211) to ‘yes’ and the Vee-session status (215) to ‘proceed.’ If a tutor, the UEP checks (207) the Tutor Calendar (206) to confirm the session for the tutor. If valid, the UEP sets (212) the Tutor Session (213) to ‘yes’ and the Vee-session status (215) to ‘proceed.’ At this point, when both users have made a confirmed connection the UEP ends.

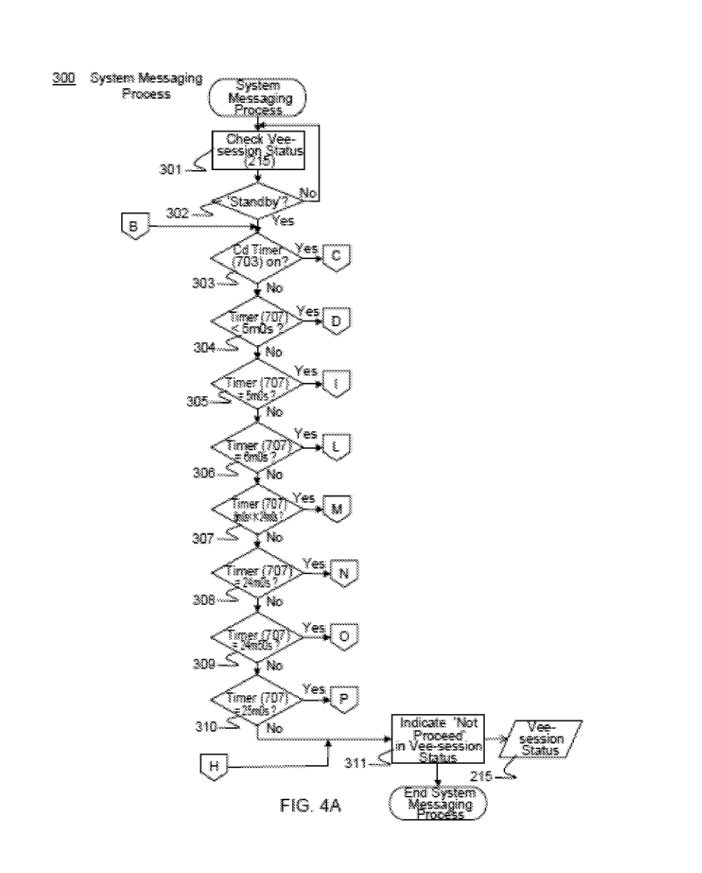

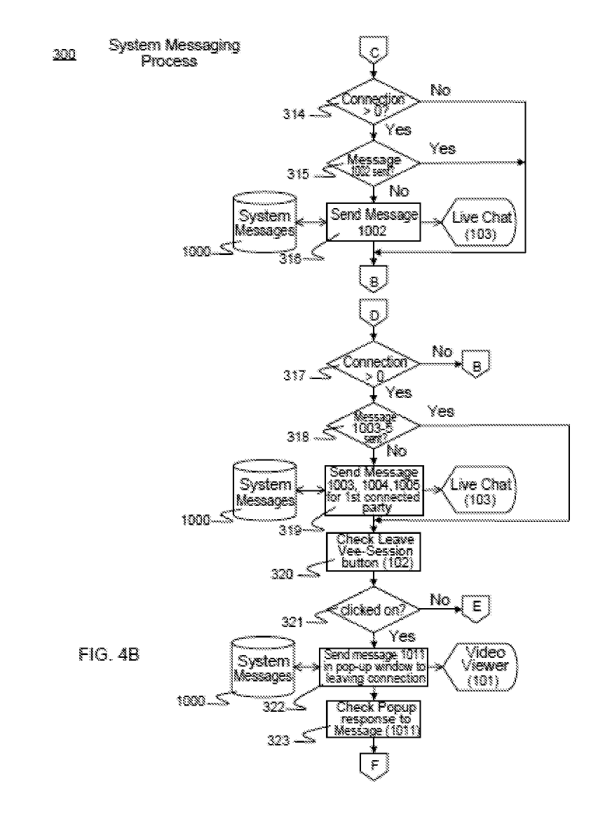

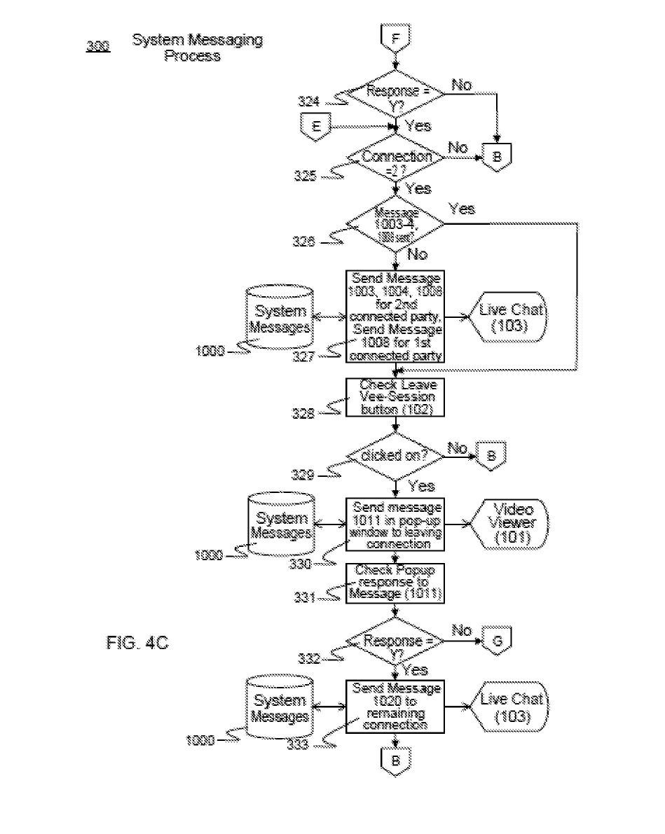

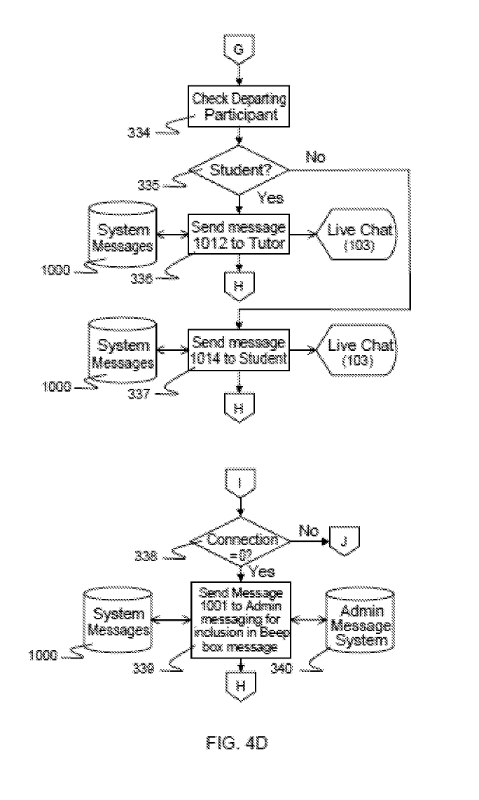

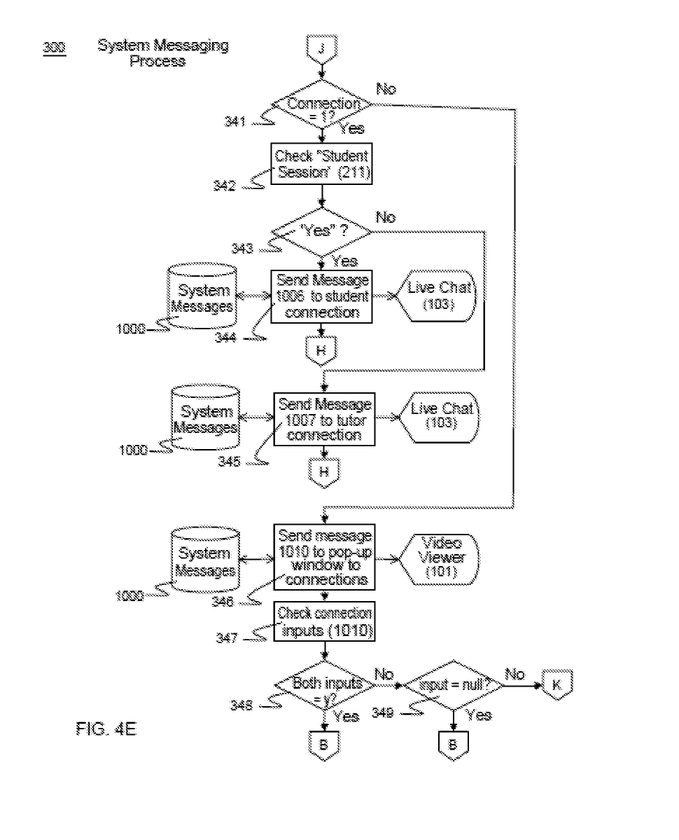

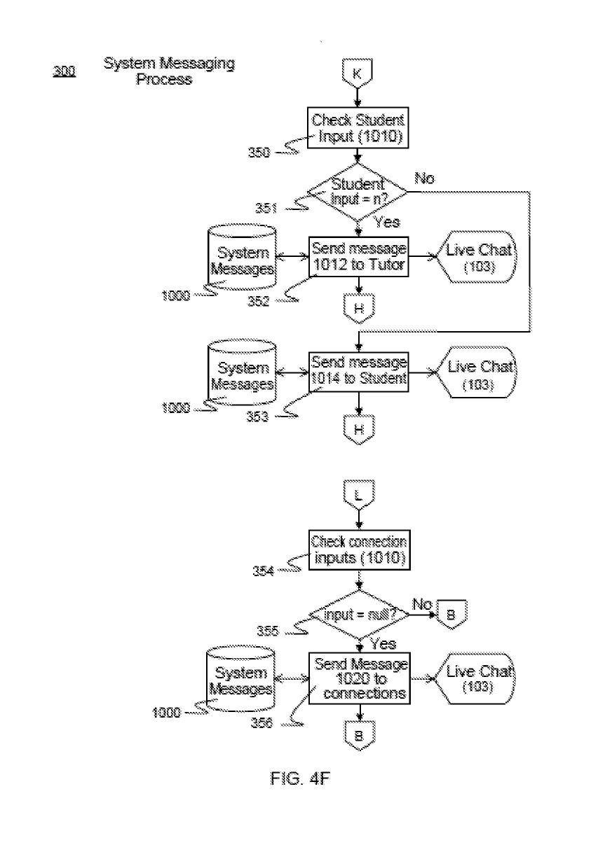

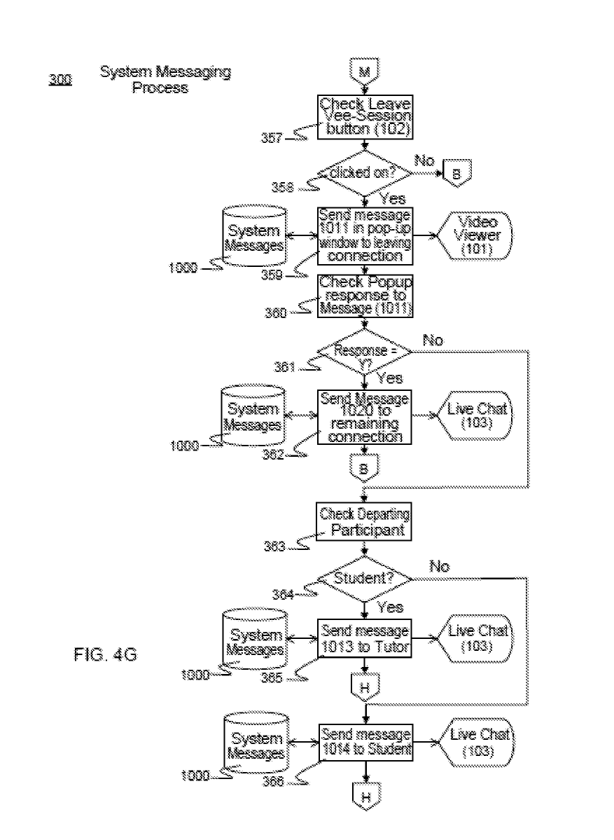

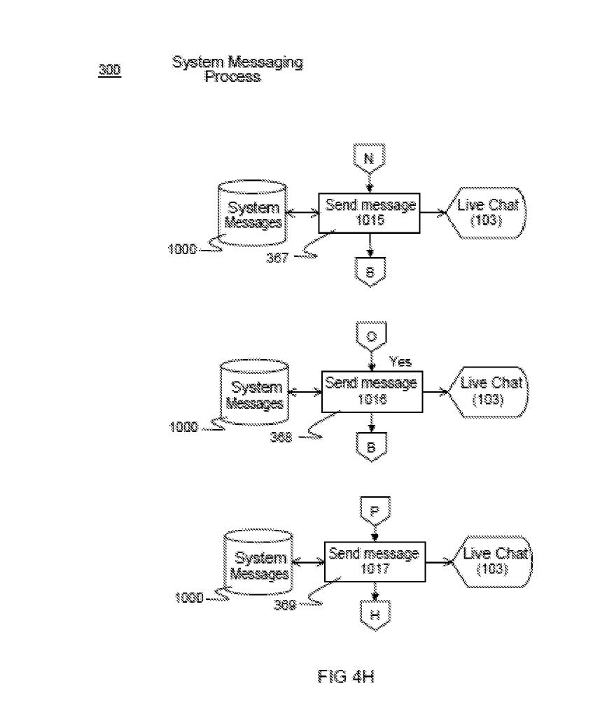

During the connections waiting period to enter the Vee Session, the System Messaging Process (SMP) monitors (303) (FIG. 4A) for connections and the Timer (707). If no connection is made when the timer (707) reaches six (6) minutes into the session, SMP (306) retrieves system message (1001) from the system message database (1000) and transfers the message to the Admin Messaging System (307) for inclusion in an email message (Beepbox) to both scheduled parties. Message 1001 states, ‘Name’ booked a session with ‘Name’ but the session did not take place. No transfer of credits or funds took place. Please remember your scheduled Vee-sessions by setting your alerts on your Beepbox page.” Where the first instance of ‘Name’ is the student and the second instance of ‘Name’ is Tutor. The SMP then activates (800) User Exit Process (UXP) steps (804 and 805) and then transfers control of the Vee-session to the Vee-Session Exit Process (VXP) (900) to close the session.

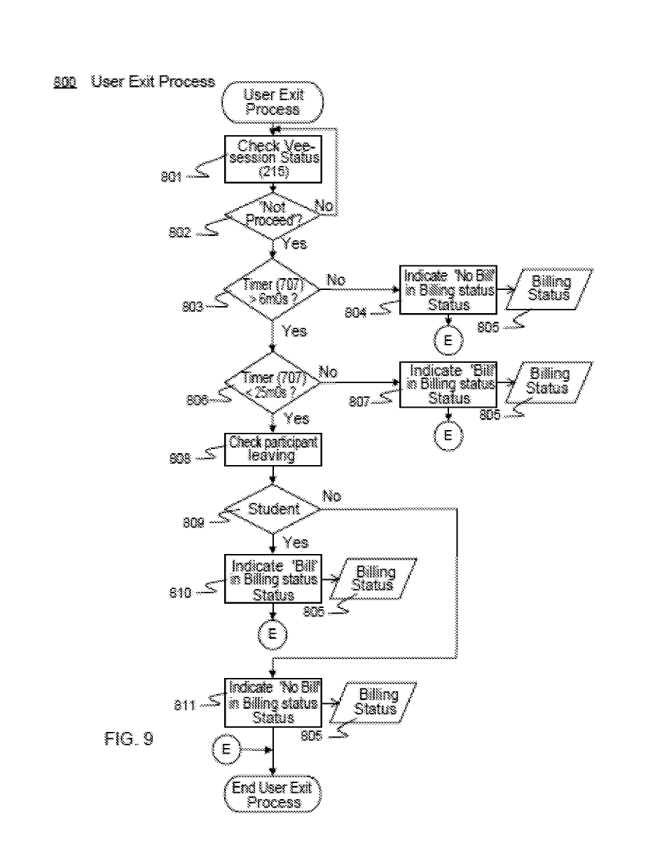

As this is an exception use case, the normal use case has the SMP waiting on the first connection. When SMP notes the entrance (303) of a connection to the Vee-session, it retrieves message (1002) from the system message database (1000) (FIG. 4B, 4C, 4D, 4E, 4F, 4G, 4H) and displays it in the Live Chat display (103) of the Vee-Session User Interface (100). This message will appear if the Countdown timer (703) is less than 2 minutes and the Vee-session has gone active (153, 154, 155, 156, 157). If the Countdown timer is greater than 2 minutes, the connected user will only see the countdown timer. Continuing the progression of the connection for the first user, the SMP will introduce messages 1003, 1004, 1005 when countdown timer=0 seconds (156). While waiting for the second party to join, the SMP continues to monitor the timer (707) (FIG. 8). Should the timer reach 5 minutes, then the SMP checks Student Session (211) for ‘yes’ indication (316). If it is ‘yes’ then the SMP sends message 1006 from the system message database (1000) to the Live Chat window (103) of the student. Additionally, the Vee-session Status (215) is set to ‘not proceed’ (216) and hands control to UXP 800 to adjust billing status (811) (FIG. 9) to ‘Not Bill’. If it is ‘no’, the SMP sends message 1007 from the system message database (1000) to the Live chat window of the tutor. Additionally, the Vee-session Status (215) is set to ‘not proceed’ (216) and hands control to UXP 800 to adjust billing status (807) to ‘Bill’.

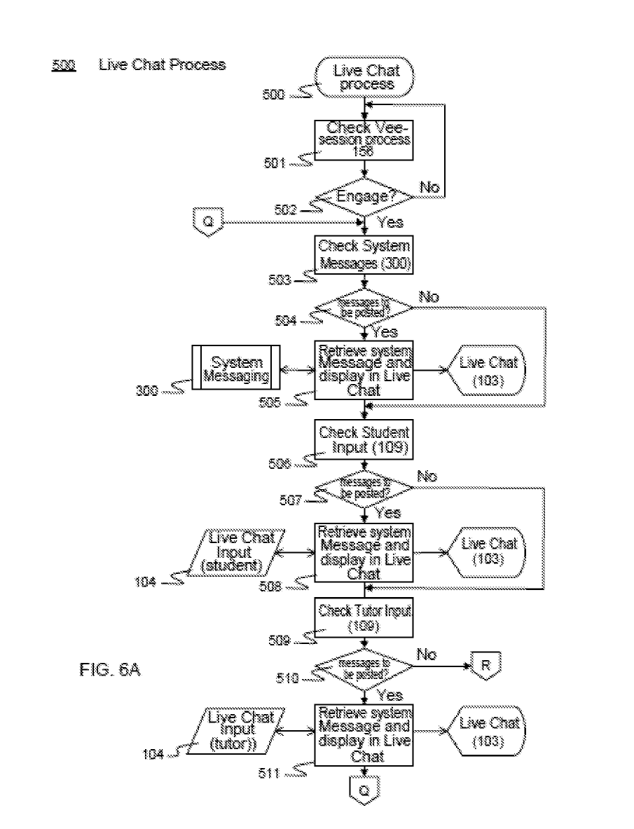

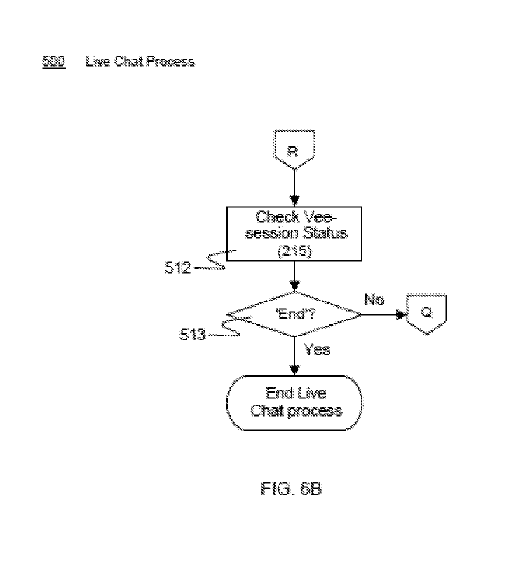

Normal use case has the second connection entering the session on time. The SMP announces the arrival of the second connected party with Message 1003, 1004, for 2nd connected party, and Message 1008 for 1st connected party in the Live Chat (103). At this point, the Vee-session Process (150) executes. At the activation of the Vee-Session Process (VSP) (150), VSP engages three processes (155, 156, and 157): the Video Viewer Process (VVP) (400) (FIG. 5), the Live Chat Process (LCP) (500) (FIG. 6A), and the Workspace Process (WSP) (600) for the duration of the Vee-session as long as the timer is less than 25 minutes and the Vee-session Status is ‘Proceed.’ (158, 159, 160, and 161).

While these processes work in parallel and are displayed in the Vee-session User Interface (100) as windows 101, 103, and 105, they are described in detail separately.

The Video Viewer Process (VVP) (400) starts when the VSP engages this process (155). The first step is to engage (404) the WebRTC app (403) in the Video Viewer (101) in the Vee-session UI. Then the Web browser app established connections with the device camera and microphone (405). The Video viewer holds until the device connections are in place (406), then once established, the Video viewer continues to stream audio and video (407) until the Vee-session Status (215) no longer indicates ‘Proceed’ (408 and 409).

The Live Chat Process (LCP) (500) (FIG. 6A) starts when the VSP engages this process (156). Once activated, the LCP rotates between three sources of messaging starting with system messages (503). If a message needs posting (504), then the LCP retrieves the message (505) from System Messaging (300) and displays it on the Live Chat window (103). The LCP progresses (506) to Student Input (104). Alternatively, if no system message (504), then the LCP progresses (506) to the Student Input (104). If the Student has entered a message (507), then the LCP retrieves the message (508) from the student input (104) in the Live Chat window (103) in the Vee-session User Interface (100) and progresses (509) to tutor input (104). Alternatively, if no Student input (507), then the LCP progresses (509) to the Tutor Input (104). If the Tutor has entered a message (510), then the LCP retrieves the message (509) from the tutor input (104) in the Live Chat window (103) in the Vee-session User Interface (100) and returns to system messages (503). Alternatively, if no Tutor input (510), then the LCP progresses to the checking Vee-Session Status (512) (FIG. 6B). If Status in not ‘end’, then the LCP returns to System Messages. The LCP continues until the VXP (919) set Vee-Session Status (215) to ‘end.’ At that point LCP stops.

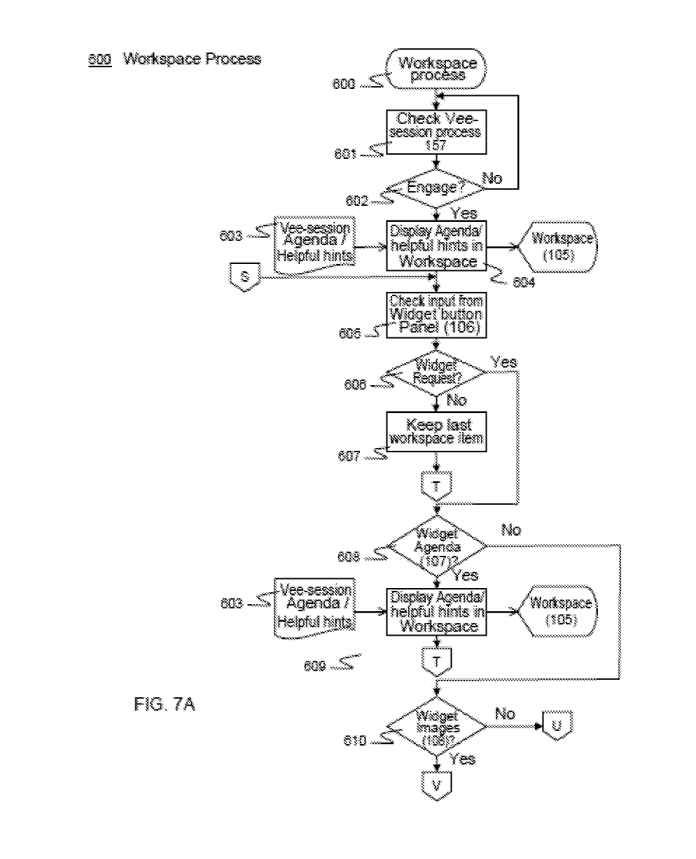

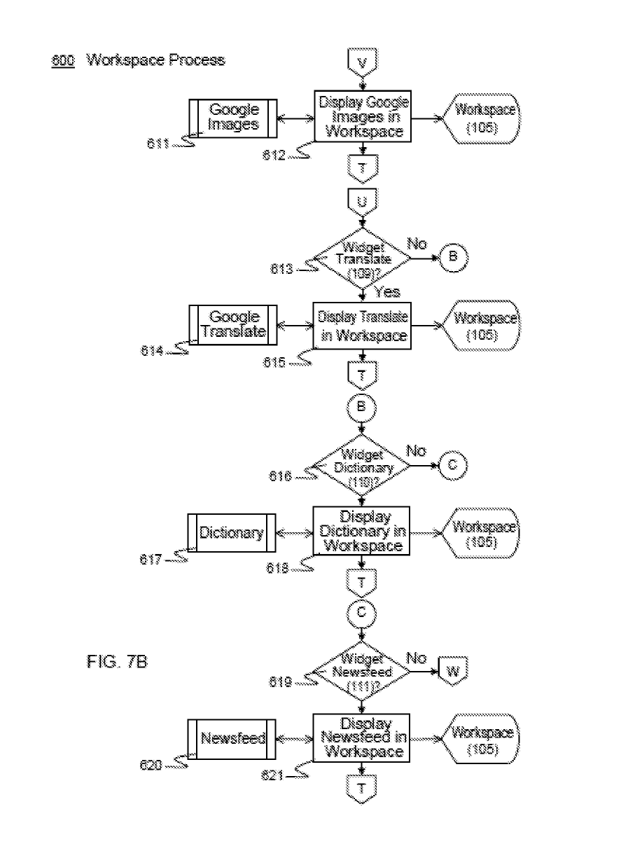

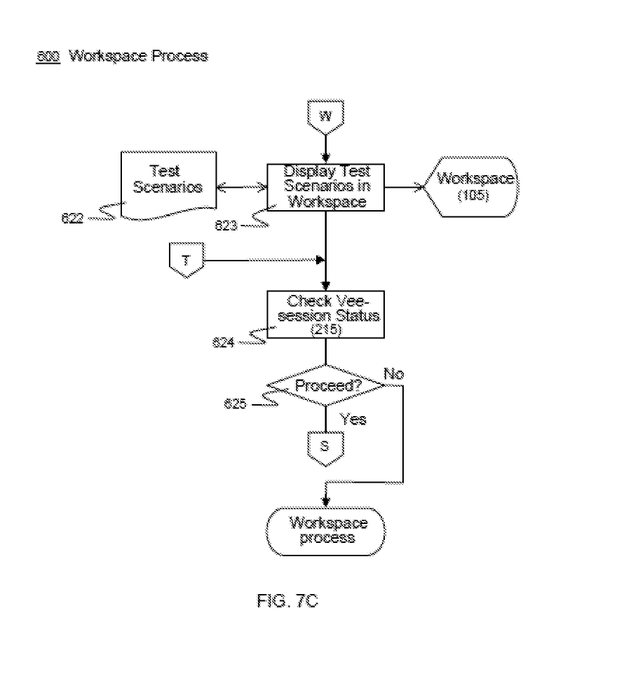

The third Pane in the Vee-Session User Interface (100) is the Workspace (105). The Workspace Process (WSP) (600) (FIG. 7A) starts when VSP engages this process (157). The WSP is an on-demand process that relies on the user pressing the buttons (107-112) in the Upper Panel (106) of the Workspace (105). The workspace first displays (604) the Vee-session Agenda/Helpful hints (603) in the workspace (105). During the course of the Vee-session, the WSP checks (605) the workspace lower panel (106). If no Widget Request is detected (606), then the last displayed item (607) stays in the workspace. The WSP process checks (617) (FIG. 7B) Vee-session Status (215) at the end of each cycle of checking for input. For brevity, the same check of Vee-session status occurs after each widget action.

If there is a Widget Request (606), then the WSP determines which widget is requested (608, 610, 613, 619, 621, and 623) (FIG. 7C). A Widget Request for ‘The Vee-session’ (107), displays (609) the Vee-session Agenda/Helpful hints (603) in the workspace (105). A Widget Request for ‘Images’ displays (612) Google Images (611) in the workspace (105). A Widget Request for ‘Translate’ displays (615) Translation Feed (614) in the workspace (105). A Widget Request for ‘Dictionary’ displays (617) Dictionary Feed (616) in the workspace (105). A Widget Request for ‘Newsfeed’ displays (621) the Newsfeed listing. A Widget Request for Test Scenarios displays (623) links to various Test Scenario (622) PDFs. When the WSP (624) finds the Vee-Session Status (215) is not ‘Proceed’, then the WSP stops.

While the VSP, Vee-session UI, and subordinate processes are active during the Vee-session, the User Exit Process (UXP) and the System Messaging Process (SMP) are background monitoring in the connection and user states. The first critical point of the Vee-session is five minutes into the Vee-session. If a user presses the ‘leave Vee-session’ button before 6 minutes have elapsed, the SMP sends message 1011 as a browser message to the connection that pressed the button. The UXP checks (803) the response. If response is ‘y’, then the UXP (807) sets User Status (808) “(FIG. 9) to ‘return’ and (809) Vee-session status (215) to ‘Proceed.’ Simultaneously, the SMP seeing the return ‘y’ (324), (325) sends message 109 from the System messages (1000) to the Live Chat display (103) and continues. If the response is ‘n,’ then the UXP (811) sets Bill Status (815) to ‘No Bill’ while the SMP checks which participant is departing.

In order to enter the Vee-session, the student first needs to find a tutor with whom they want to have a conversation. To accomplish finding a tutor, the Student starts by going to the Tutor Search User Interface (1100). The Student is generally led to this user Interface from the initial landing pages; more importantly and regardless of how the student arrives to this page, this UI is the gateway for the student's engagement with tutors. The Tutor Search User Interface consists of four components: “Build a Tutor” (1101) search and filtering field, TheTalkMap (1111) a graphical depiction of Tutors' locations, sorting tools (1112), Featured Tutors (1113), and More Search Results (1115).

The Build a Tutor pane (1101) allows the student to select criteria to cull and filter the search for desirable tutors. A series of drop down menus are available for the student to refine their search. The available criteria are: language (1102), second language (1103), Maximum credits cost (1104), gender (1105), location—subdivided into country, state/province, and city (1106), open timeslots (1107), search by keywords (1108) and search by schools) (1109). The student can use any or all of these criteria to filter and find the tutor of their choice. When they are finished with their selections, they press the Search button (1110) and they can view the results in the ‘more results’ pane (1115).

Students also have the option of selecting tutors from the Featured tutors pane (1113) or clicking on location pins in TheTalkMap (1111). For the lists of tutors, the student sort by Rating, Name, or Price (1112). Students can get further Tutor details by clicking on the profile picture (1115) to view the tutor Profile Page (1200). On this page, they can send a Beepbox message (1204) which sends a message to Tutor Beepbox (1504), They can request a Talk Now session (1205) which initiates TNP (1350). They can save the tutor as a favorite (1206) which saves a particular tutor in their My Tutors list (1554). Within the Tutor Profile Page (1200), the Student can view a video greeting (1207), view biographical information including personal, academic, an professional sections (1208), view availability in their calendar (1209), view the tutor's overall star rating (1210), and view comments left by other students (1211)

From the Tutor profile page, the student will interact with the Calendar (1209) so that they can book a Vee-session. This is the same calendar that the student will arrive at if they had pressed Schedule icon (1118) on the Tutor Search User Interface (1115) or the MyTutors page (1554).

This Calendar interface works with the Scheduling Process (SP) (1310) for both parties. A Tutor clicks on individual timeslots (1312) to ‘Open’ the green highlighted sessions' for each day of the month. The ‘Open’ sessions are recorded by the SP (1315) into the Tutor Calendar (206).

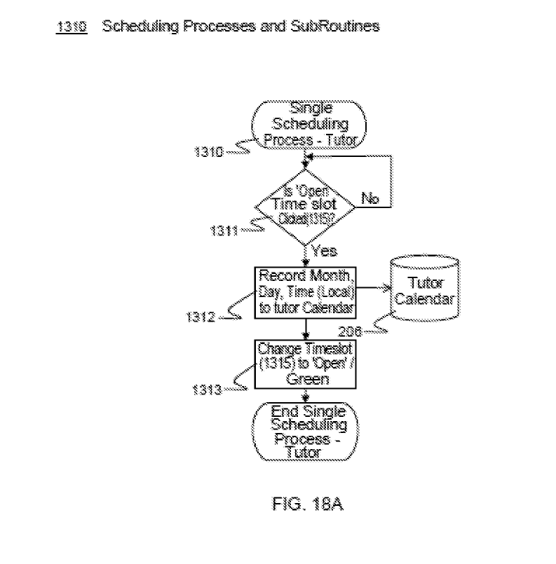

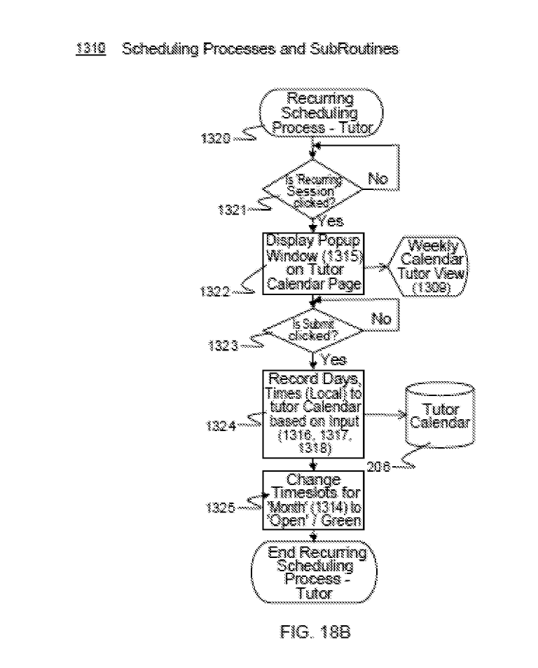

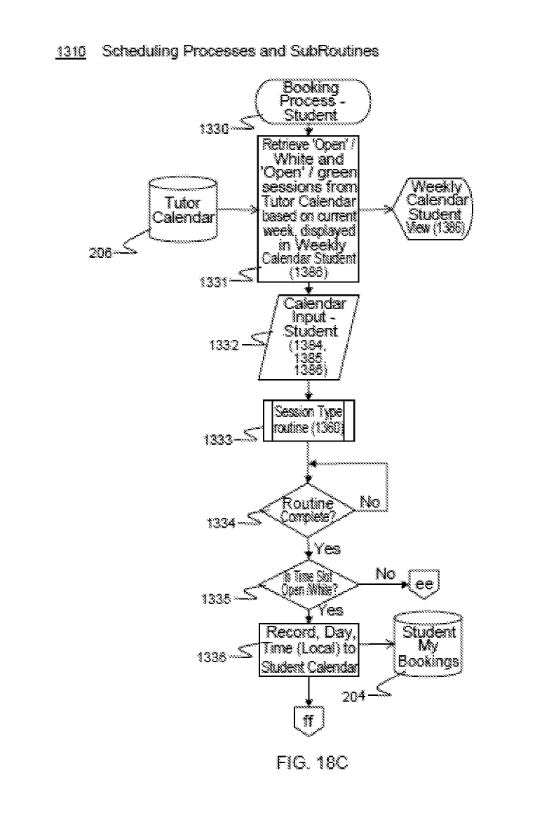

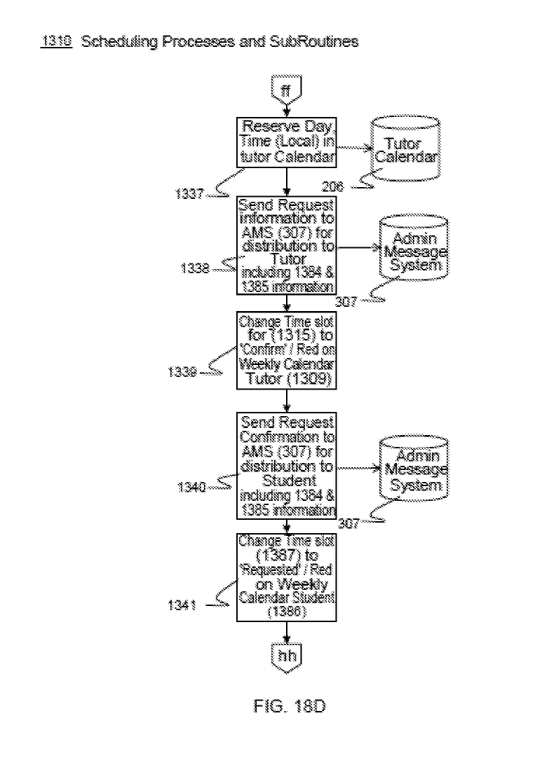

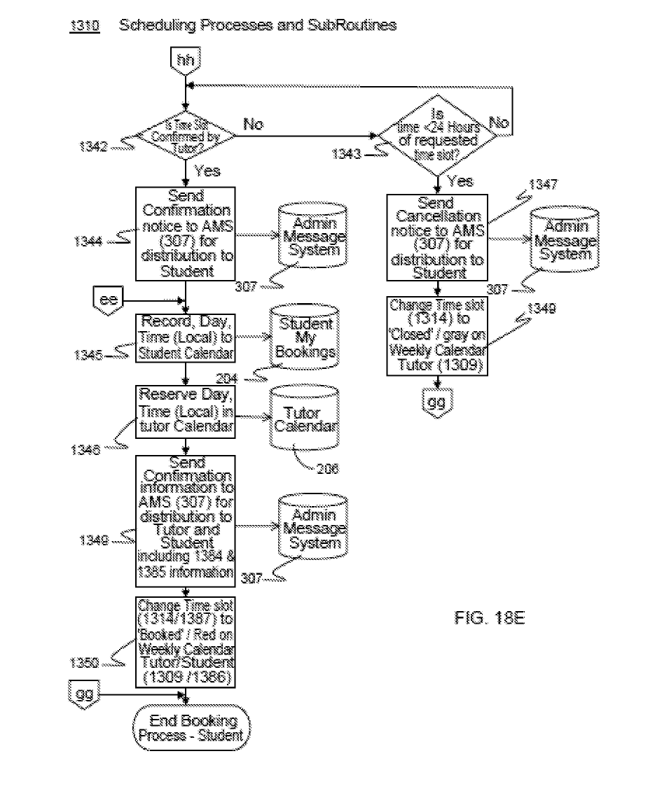

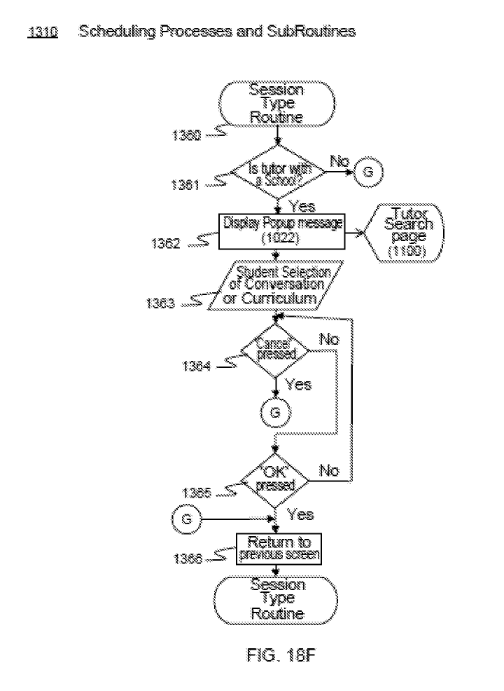

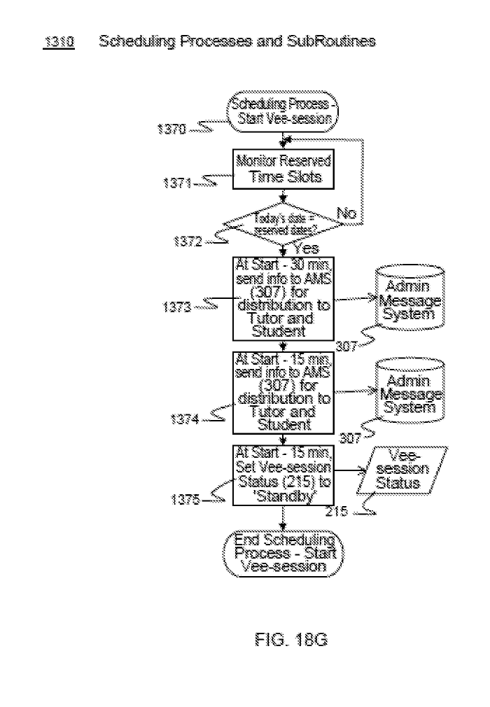

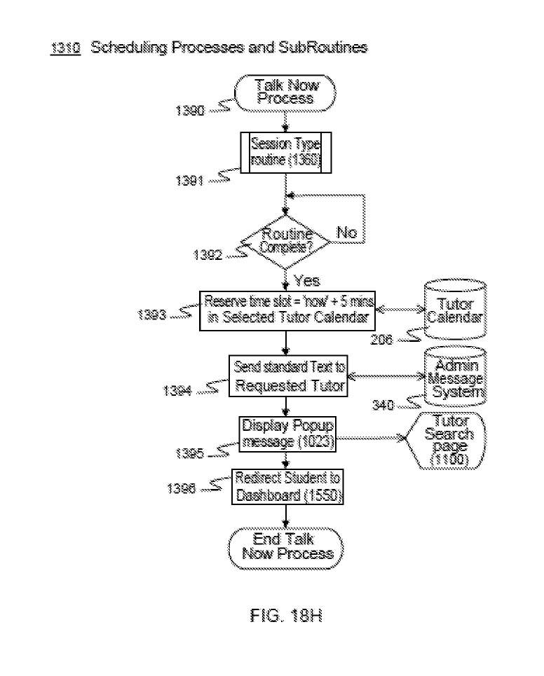

The student initiates the booking by first selecting their speaking level (1354) and the topic (1355). Thereafter the booking may proceed in 3 ways. First, the student may click the ‘Open’ (1332) highlighted sessions for any timeslot, the AMS will send (1336) either request or confirmation messages to both parties and will execute a user interface change to ‘Booked’(1337) in both calendars. Secondly, the student may click the ‘Requested’ (1332) highlighted sessions for any timeslot, the AMS will send (1336) either request or confirmation messages to both parties and will execute a user interface change to ‘Requested’(1337) for the Student calendar and ‘Confirm’ (1338) in the Tutor calendar. When Tutor clicks (1340) to ‘Confirm’ the appointment, then confirmation messages will be sent and Timeslot status will change (1347, 1348) on Student and Tutor's calendars to ‘Booked’. Thirdly, the student may want an on-demand tutor and click the ‘Talk Now’ icon (1119, 1205, 1351) to start the Talk Now Process (1350). In all three cases, the student is sent through the Session Type Routine (1360) to determine the session type: conversation or curriculum (1363) which is presented with different rates that are tracked by the Credit Accounting Process (CAP) (916). In all 3 cases, the session(s) are recorded by the SP (1334) into the Student My Bookings Page (204), (1335) Reserves the slot in the Tutor Calendar (207), and (1336) (FIG. 18C) sends notification information to the Admin Message System (AMS) (307) for distribution. The AMS sends messages via BeepBox (email) to the Student and Tutor confirming the booking.

The SP (1370) monitors the reserved sessions and (1373) sends information to the AMS (307) at thirty (30) minutes prior to the start of the Vee-session. At fifteen (15) minutes prior to the Start, the SP (1374) (FIG. 18G) sends the final message to AMS (307). At 15 (15) minutes prior to the Start of the Vee Session, the SP (1335) sets the Vee-session Status (215) to ‘Standby’.

To enter the Vee-session, the users will select Join from the Student My Bookings page (1305), or their respective dashboards (1514). In the case that they need to cancel a session, they can click Cancel Class (1304) which will launch the AMS (1000) to send a cancellation email message to both parties.

The Credit Accounting Process (CAP) (916) (FIG. 10B) assesses the correct adding and subtracting of credits to users that perform transactions. The CAP determines (915) (FIG. 10B) if a session is classified as ‘conversation’. If so then, the Student Account is debited (917) and the Tutor Account (918) and TTL Account (919) is credited. If the session is not classified as ‘conversation’, then it is classified (915) as ‘curriculum’. Then, the Student Account is debited (917) and the Tutor Account (918), TTL Account (919), and School Account (920) is credited. In the case that a scheduled session does not happen (914), then the CAP will automatically enable the reverse the credit accounting process (921). This would reimburse the Student Account (917) for credits rendered to book a session.

Although the invention has been described with reference to the above examples, it will be understood that modifications and variations are encompassed within the spirit and scope of the invention. Accordingly, the invention is limited only by the following claims.

What is claimed is:

1. An interactive online tutorial, language learning system for providing language learning instruction from a tutor to a student on a digital processing platform, the digital processing platform comprising a search and scheduling engine that connects a student with an appropriate tutor wherein the student accesses a search process that allows a student to find an appropriate tutor wherein the student can search for a tutor by keyword or preferences or they can search by geographical location, wherein the search engine provides a search engine filter to filter results based on integrated grading system of tutors, by location, or visual inspection of the tutor's profile, wherein the upon identifying an appropriate tutor, the student schedules a tutor session with the selected tutor by means of an online calendar that coordinates the available sessions for both tutors and students across all time zones and international boundaries.

2. The interactive online tutorial, language learning system of claim 1 wherein the platform further comprises a fully functional videoconference tutoring Vee-session wherein the student and tutor enter a Vee-session site from a web site that has allows the student and tutor to enter into a tutoring session for a 25-minute conversation period, wherein the Vee-session occurs within a fully automated site that controls the start and finish to the session wherein, the student and the tutor engage in a video conversation and make use of available language learning tools to help the student improve their conversation skills.

3. The interactive online tutorial, language learning system of claim 2 wherein, the language learning tools of the Vee-session further comprises a flexible learning environment that provides students with translations; definitions; images; current news, and test scenarios during the tutoring session to help the student view and better understand the language being learned.

4. The interactive online tutorial, language learning system of claim 1 wherein, the platform further comprises an online repository for learning and teaching materials which can be accessed by the tutor during a tutoring session, the repository further comprising multimedia materials and links that are consistently updated to include new translations relating to current events and the news.

5. The interactive online tutorial, language learning system of claim 1 wherein, the platform further comprises a functional social networking site wherein, a student and tutor have access to an email system, that is also linked to their personal email; a live chat site where the student and tutor can communicate in real time; and connections to other social networking platforms to expand their access to their friends from the site.

6. The interactive online tutorial, language learning system of claim 1 wherein, the platform further comprises a fully monitored and controlled marketplace platform wherein a tutor sets his own pay rate and a student chooses the rates they wish to pay wherein, the start and finish times for the Vee-session are controlled, monitored and presented in automated messages to clarify the parameters of the Vee-session to the student and tutor, the Vee-session further comprising a billing module to record time spent in the session for invoicing purposes, wherein, the billing module issues refunds for unattended tutoring or cancelled tutoring sessions.

7. The interactive online tutorial, language learning system of claim 1 wherein, the platform is available to browser applications for desktop operating systems and mobile applications for smart-phone and tablet operating systems.

8. A computer-implemented method for establishing peer-to-peer communication between a tutor and a student for the purpose of setting and conducting a tutoring session for language learning between the student and the tutor on an on-line medium comprising a digital processing platform, the digital processing platform comprising a search and scheduling engine that connects a student with an appropriate tutor wherein the student accesses a search process to find an appropriate tutor wherein the student can search for a tutor by keyword or preferences or they can search by geographical location, wherein the search engine provides a search engine filter to filter results based on integrated grading system of tutors, by location, or visual inspection of the tutor's profile, wherein the upon identifying an appropriate tutor, the student schedules a tutor session with the selected tutor by means of an online calendar that coordinates the available sessions for both tutors and students across all time zones and international boundaries.

9. An interactive online tutorial, language learning system for providing language learning instruction from a tutor to a student on a digital processing platform, the digital processing platform further comprising a Vee-session, the Vee-session further comprising a scheduling process, a Student Calendar, a Vee-session Process, a System Messaging Process, a timer, a User Entry Process, a Tutor calendar, a Tutor Session, an Admin messaging system and a User Exit Process.

10. The interactive online tutorial, language learning system of claim 9 wherein, the Vee-session Process waits in a standby mode until a qualified connection joins the Vee-session, wherein, the User Entry Process monitors for the connection and determines if the connection is associated with the tutor or the student, wherein if a student, the User Entry Process checks the Student Calendar to confirm the session and if a tutor, the User Entry Process checks the Tutor Calendar to confirm the session for the tutor wherein, the User Entry Process ends when both users have made a confirmed connection.

11. The interactive online tutorial, language learning system of claim 9 wherein, the System Messaging Process monitors for connections and the Timer wherein, if no connection is made when the timer reaches three minutes into the tutoring session, the System Messaging Process retrieves a system message from a system message database and transfers the message to the Admin Messaging System for inclusion in an email message to the student and the tutor, wherein the System Messaging Process activates the User Exit Process and transfers control of the Vee-session to a Vee-Session Exit Process to close the tutoring session.

12. The interactive online tutorial, language learning system of claim 9 further comprising a Video Viewer Process, a Live Chat Process and a Vee-session User Interface.

13. The interactive online tutorial, language learning system of claim 12 wherein, the Video Viewer Process engages an WebRTC app in a Video Viewer in a Vee-session UI, wherein a Web browser app establishes connections with the device camera and microphone, wherein, the Video viewer waits until device connections are established, whereupon the Video viewer continues to stream audio and video until the Vee-session ends.

14. The interactive online tutorial, language learning system of claim 9 wherein the student enters the Vee-session, and finds an appropriate tutor by accessing a Tutor Search User Interface wherein the Tutor Search User Interface comprises four components of the platform: 1) a “Build a Tutor” search and filtering field, 2) TheTalkMap, a graphical depiction of Tutors' locations, 3) Featured Tutors, and 4) Search Results, wherein the Build a Tutor pane allows the student to select critieria to filter the search for desirable tutors.

15. The interactive online tutorial, language learning system of claim 14 wherein the Build a Tutor pane further comprises a series of drop down menus are available for the student to refine their search, the drop down menus further comprising search criteria including desired language, second language, Maximum credits cost, gender, location—subdivided into country, state/province, and city, current availability, and keyword search.
